(19) United States
(12) Patent Application Publication
(10) Pub. No.: US 2021/0366133 A1
(43) Pub. Date: Nov. 25, 2021

(54) IMAGE FRAME PREDICTION METHOD, IMAGE FRAME PREDICTION APPARATUS AND HEAD DISPLAY APPARATUS

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Jiyang Shao, Beijing (CN); Yuxin Bi, Beijing (CN); Jian Sun, Beijing (CN); Hao Zhang, Beijing (CN); Feng Zi, Beijing (CN)

(73) Assignees: BEIJING BOE OPTOELECTRONICS TECHNOLOGY CO., LTD., Beijing (CN); BOE TECHNOLOGY GROUP CO., LTD., Beijing (CN)

(21) Appl. No.: 16/618,248

(22) PCT Filed: Jun. 27, 2019
(86) PCT No.: PCT/CN2019/093296

§ 371 Date: Nov. 29, 2019

(30) Foreign Application Priority Data
Jan. 11, 2019 (CN) 201910027712.5

(51) Int. Cl. G06T 7/277; G06T 7/215; G06T 5/00

(52) U.S. Cl. CPC G06T 7/277; G06T 7/215; G06T 2207/20081; G06T 2207/20084; G06T 5/006

(57) ABSTRACT

The disclosure relates to a method of image frame prediction in a display apparatus. The method may comprises performing inter-frame motion vector calculation on every two adjacent source frames to obtain a plurality of frame motion vectors, wherein the source frames are rendered frames: performing inter-frame motion vector prediction based on at least two adjacent frame motion vectors of the plurality of frame motion vectors to obtain a frame motion vector prediction value; and processing a source frame closest to the frame motion vector prediction value based on the frame motion vector prediction value to obtain a predicted frame. The source frame closest to the frame motion vector prediction value may be the last source frame used in obtaining the frame motion vector prediction value.

### CROSS-REFERENCE TO RELATED APPLICATIONS

This application claims benefit of the filing date of Chinese Patent Application No. 201910027712.5 filed on Jan. 11, 2019, the disclosure of which is hereby incorporated in its entirety by reference.

### TECHNICAL FIELD

The present disclosure relates to the field of image processing, and in particular, to an image frame prediction method, an image frame prediction apparatus, and a head display apparatus.

### BACKGROUND

AR/VR (Augmented Reality/Virtual Reality) products require high resolution, fast frame rate, and low latency. Under a certain latency requirement, complex scenes and high frame rates have high requirements for image rendering and data transmission. However, the huge data processing and rendering work brings huge technical challenges to graphics processors (GPUs), graphics cards, application processors (APs) cir wireless data transmission.

### BRIEF SUMMARY

An embodiment of the present disclosure provides a. method of image frame prediction in a display apparatus. The method may comprises performing inter-frame motion vector calculation on every two adjacent source frames to obtain a plurality of frame motion vectors, wherein the source frames are rendered frames; performing inter-frame motion vector prediction based on at least two adjacent frame motion vectors of the plurality of frame motion vectors to obtain a frame motion vector prediction value; and processing a source frame closest to the frame motion vector prediction value based on the frame motion vector prediction value to obtain a predicted frame. The source frame closest to the frame motion vector prediction value may be the last source frame used in obtaining the frame motion vector prediction value.

Optionally, the method further comprises inserting the predicted frame after the source frame closest to the frame motion vector prediction value.

Optionally, the every two adjacent source frames comprises a first source frame and a second source frame, the second source frame is a subsequent frame of the first source frame in time series, and performing inter-frame motion vector calculation on every two adjacent source frames to obtain the plurality of frame motion vectors comprises dividing the first source frame into a plurality of unit blocks; finding a matching block in the second source frame corresponding to each, of the plurality of unit blocks in the first source frame; and calculating a motion vector between each of the plurality of unit blocks in the first source frame and its corresponding matching block in the second source frame, thereby obtaining a frame motion vector between the first source frame and the second source frame.

Optionally, performing inter-frame motion vector prediction based on at least two adjacent frame motion vectors of the plurality of frame motion vectors to obtain a frame motion vector prediction value comprises inferring the frame motion vector prediction value based on the at least two adjacent frame motion vectors and a displacement pattern; calculating the frame motion vector prediction value based on the at least two adjacent frame motion vectors according to a Kalman filter algorithm; or using an artificial neural network algorithm model derived from training to predict the frame motion vector prediction value.

Optionally, processing the source frame closest to the frame motion vector prediction value based on the frame motion vector prediction value to obtain the predicted frame comprises shifting pixels in the unit blocks in the source frame closest to the frame motion vector prediction value according to the frame motion vector prediction value to obtain the predicted frame.

Optionally, before the performing inter-frame motion vector calculation on every two adjacent source frames to obtain a plurality of frame motion vectors, the method further comprises extracting two adjacent source frames from a storage module.

Optionally, the display apparatus comprises a lens capable of generating distortion, and the method further comprises performing inverse distortion processing on the predicted frame and the source frame

Optionally, the method, after inserting the predicted frame after the source frame closest to the frame motion vector prediction value, further comprises outputting the predicted frame and the source frame closest to the frame motion to a display module.

Optionally, the two adjacent source frames comprises a first source frame and a second source frame, a predicted frame of the first source frame is a copy of the first source frame, and a predicted frame of the second source frame is a copy of the second source frame.

One embodiment of the present disclosure is an image flame prediction apparatus. The image frame prediction apparatus comprises a frame motion vector calculator, a motion vector predictor, and a prediction frame constructor. The frame motion vector calculator is configured to perform inter-frame motion vector calculation on every two adjacent source frames to obtain frame motion vectors of the every two adjacent source frames, where the source frames are rendered frames the motion vector predictor is configured to perform inter-frame motion vector prediction based on at least two adjacent frame motion vectors of the plurality of frame motion vectors to obtain a frame motion vector prediction value; and the prediction frame constructor is configured to process a source frame closest to the frame motion vector prediction value according to the frame motion vector prediction value to obtain a predicted frame, wherein the source frame closest to the frame motion vector prediction value is the last source frame used in obtaining the frame motion vector prediction value.

Optionally, the image frame prediction apparatus further comprises an inserting frame processor, wherein the inserting frame processor is configured to insert the predicted frame behind the source frame closest to the frame motion vector prediction value.

Optionally, the image frame prediction apparatus further comprises an inverse distortion processor before the inserting frame processor, wherein the inverse distortion processor is configured to perform inverse distortion processing on the predicted frame.

Optionally, the every two adjacent source frames comprises a first source frame and a second source frame, the second source frame is a subsequent frame of the first source frame in time series, and the frame motion vector calculator is configured to divide the first source frame into a plurality of unit blocks; find a matching block in the second source frame corresponding to each of the plurality of unit blocks in the first source frame; and calculate a motion vector between each of the plurality of unit blocks in the first source frame and its corresponding matching block in the second source frame to obtain a frame motion vector between the first source frame and the second source frame.

Optionally, the motion vector predictor obtains the frame motion vector prediction value in one of the following manners: inferring the frame motion vector prediction value based on the at least two adjacent frame motion vectors and a displacement pattern; calculating the frame motion vector prediction value based on the at least two adjacent frame motion vectors according to a Kalman filter algorithm; or using an artificial neural network algorithm model derived from training to predict the frame motion vector prediction value.

Optionally, the prediction frame constructor is configured to shift pixels in the unit blocks in the source frame closest to the frame motion vector prediction value according to the frame motion vector prediction value to obtain the predicted frame.

Optionally, the image frame prediction apparatus further comprises an image extractor before the frame motion vector calculator, wherein the image extracting unit is configured to extract two adjacent source frames from a storage module.

One embodiment of the present disclosure is a head display apparatus, comprising the image frame prediction apparatus according to one embodiment of the present disclosure.

One embodiment of the present disclosure is a computer product, comprising one or more processors, the one or more processors is configured to implement the image frame prediction method according to one embodiment of the present disclosure.

One embodiment of the present disclosure is a non-transitory computer-readable medium storing instructions that cause a computer to execute the method according to one embodiment of the present disclosure.

### BRIEF DESCRIPTION OF TIS DRAWINGS

The drawings are used to provide a further understanding of the technical solutions of the present disclosure, and constitute a part of the specification, which together with the embodiments of the present application are used to explain the technical solutions of the present disclosure, and do not constitute a limitation of the technical solutions of the present disclosure. The shapes and sizes of the various components in the drawings do not reflect true proportions, and are merely intended to illustrate the present disclosure.

FIG. 1 is a flowchart of an image frame prediction method according to one embodiment of the present disclosure;

FIG. 2 is a diagram showing a prediction method according to one embodiment of the present disclosure;

FIG. 3(a) shows an application of the image frame prediction method to an single screen AR/VR head display apparatus.

FIG. 3(b) shows an application of the image frame prediction method to a double screens AR/VR head display apparatus.

FIG. 4 is a schematic structural diagram of an image frame prediction apparatus according to one embodiment of the present disclosure;

FIG. 5 is a schematic structural diagram of an image frame prediction apparatus according to one embodiment of the present disclosure;

FIG. 6 is a flowchart of a spatial prediction method according to one embodiment of the present disclosure;

FIG. 7 is a schematic structural diagram of a computer product according to one embodiment of the present disclosure.

### DETAILED DESCRIPTION

The specific embodiments of the array substrate, the electroluminescent display panel, and the display device provided by the embodiments of the present disclosure are described in detail below with reference to the accompanying drawings. It is understandable that the preferred embodiments described herein are intended to illustrate and explain the disclosure and are not intended to limit the disclosure. The embodiments in the present application and the features in the embodiments can be recombined with one another without causing. conflicts. It should be noted that the dimensions and shapes of the various figures in the drawings do not reflect the true proportions, and are merely intended to illustrate the present disclosure. The same or similar reference numerals indicate the same or similar elements or elements having the same or similar functions.

In addition, the terms “first” and “second” or the like are for illustration purposes only and are not to he construed as indicating or implying relative importance or implied reference to the quantity of indicated technical features. Thus, features defined by the terms “first” and “second” may explicitly or implicitly include one or more of the features. In the description of the present disclosure, the meaning of “plural” is two or more unless otherwise specifically and specifically defined.

During rendering, if the rendering performance of a certain frame of data is insufficient, for example, the graphics content is too complex to render for too long and the output frame rate is high, the GPU cannot render the image in time according to the frame rate and provide display. Then, the next frame of data will be lost so that the Head Mounted Visual Apparatus (HMD) display the same image data as the previous frame of data, thereby causing a frustration or abnormal display.

In the related arts, there is a frame rate up conversion algorithm based on motion compensation. The motion estimation is performed on the previous original frame and the current original frame. After the motion data is obtained, vector processing is performed, and motion vectors are obtained. Then, motion compensation is performed, and finally an inserted frame is obtained.

If the frame rate up conversion algorithm based on motion compensation is directly used for AR/VR to increase frame rate up (such as 60 Hz to 120 Hz), a large latency (at least close to 2 frames) will be introduced, which is unacceptable by AR/VR.

The method of the embodiment of the present disclosure is described in detail below:

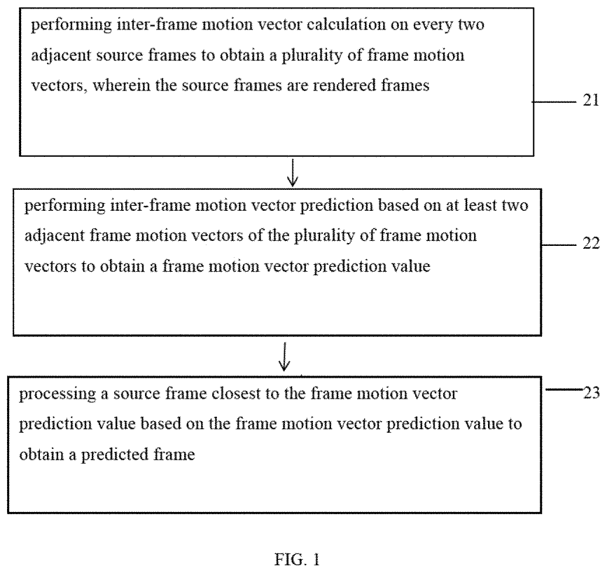

As shown in FIG. 1, the image frame prediction method according to one embodiment of the present disclosure includes steps 21-23.

Step 21 includes performing inter-frame motion vector calculation on two adjacent source frames to obtain a frame motion vector (or inter-frame motion vector) of the adjacent two source frames, where the source frame is a rendered frame.

In one embodiment, step 21 includes performing inter-frame motion vector calculation on a first source frame and a second source frame to obtain a frame motion vector between the first source frame and the second source frame (hereinafter referred to as frame motion vector 1), performing inter-frame motion vector calculation on the second source frame and the third source frame to obtain a frame motion vector between the second source frame and the third source frame (hereinafter referred to as frame motion vector 2), and so on. The source frames such as the first source frame, the second source frame, and the third source frame are all rendered frames. The second source frame is a subsequent frame (or the next frame in time series) of the first source frame in time series, and the third source frame is a subsequent frame of the second source frame in time series.

Step 22 includes performing inter-frame motion vector prediction based on at least two frame motion vectors to obtain a frame motion vector prediction value.

In one embodiment, the inter-frame motion vector prediction is performed based on the frame motion vector 1 and the frame motion vector 2, and accordingly a frame motion vector prediction value, that is, a predicted frame motion vector, is obtained. For example, the prediction may be performed based on a pattern of the frame motion vector. In one embodiment, assuming the motion is linear motion, the next frame motion vector may be predicted based on the frame motion vector 1 and the frame motion vector 2, and accordingly, it is possible to predict the position of the object in the same position of the image in the next frame.

The more frame motion vectors used in inter-frame motion vector prediction, the more accurate the prediction.

Step 23 includes processing the source frame closest to the frame motion vector prediction value based on the frame motion vector prediction value to obtain a predicted flame.

The source frame closest to the frame motion vector prediction value refers to the last source frame used in calculating the frame motion vector prediction value, or the last source frame in time series in all source frames participating in the calculation of the frame motion vector prediction value. For example, the first source frame and the second source frame are calculated to obtain a corresponding frame motion vector 1. The second source frame and the third source frame are calculated to obtain a corresponding frame motion vector 2. The frame motion vector 3′ is predicted from the frame motion vector 1 and the frame motion vector 2. The last source frame used in the calculation of the frame motion vector 3′ is the third source frame. The third source frame is processed based on the frame motion vector 3′ to obtain a predicted frame. That is, the predicted frame is the next frame of the third source frame.

With the above method, the predicted frame is obtained based on the rendered source frames, and there is no need to render the predicted frame, which reduces the rendering workload and the latency.

In one embodiment, after the foregoing step 23, the following steps may be further included:

Step 24 includes inserting and displaying the predicted frame after the source frame closest to the frame motion vector prediction value.

By inserting and displaying the predicted frame, the display frame rate of the AR or VR can be increased. At the same time, since the inserted frame, that is, the predicted frame is obtained by prediction of the motion vectors, it does not need rendering. Accordingly, the rendering workload is small and the latency is small.

In one embodiment, before outputting the predicted frame (such as before step 24). the method further comprises performing inverse distortion processing on the predicted frame. When the display device uses the lens, distortion may occur. Thus, the inverse distortion processing is performed before the image output is displayed to ensure the display effect.

In one embodiment, the foregoing step 21 can be implemented in the following manner:

Step 211 includes dividing the first source frame into a plurality of unit blocks;

Each unit block contains the same number of pixels. The unit block can be a block of a preset size. For example, the preset unit block size may be 16*16 pixels or 32*32 pixels.

Step 212 includes finding a matching block in the second source frame corresponding to each unit block in the first source frame.

The second source frame is the next frame of the first source frame in time series.

In one embodiment, a block closest to each unit block in the first source frame can be found within a given area of the second source frame according to a certain criterion, and the block is the corresponding matching block. One of ordinary skill in the art is familiar with how to find matching blocks in two frames, which are not described herein again.

Step 213 includes calculating a motion vector between each unit block in the first source frame and its corresponding matching block, thereby obtaining the frame motion vector between the first source frame and the second source frame.

The displacement between each unit block and the corresponding matching block is a motion vector. The number of motion vectors in one frame is the number of unit blocks.

A frame motion vector corresponding to two source frames can be obtained by the above steps 211-213, and the above steps can be repeatedly performed to obtain a plurality of frame motion vectors.

In one embodiment, the foregoing step 22 can be implemented in the following manner:

Step 221 includes inferring the frame motion vector prediction value by analogy based on the frame motion vectors and the displacement pattern.

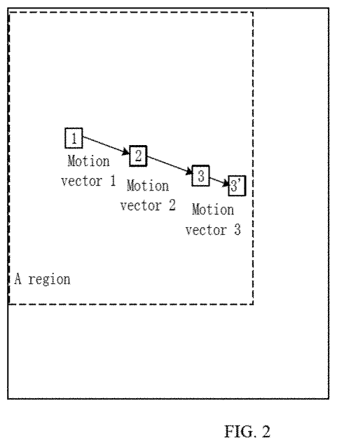

In one embodiment, as shown in FIG. 2, the position 1 unit block (block 1) is a unit block in the image of the first source frame (frame 1), and the position 2 unit block (block 2) is the unit block in the image of the second source frame (frame 2) that is closest to the pixel in the unit block of the frame 1 image. That is, block 2 is the matching block in frame 2 corresponding to block 1. The position 3 unit block (block 3) is the unit block in the image of the third source frame (frame 3) that is closest to the pixel in the unit block of frame 2 image. That is, block 3 is a matching block in frame 3 corresponding to block 2. According to block 1 and block 2, motion vector 1 (the arrow between block 1 and block 2 in FIG. 2) can be obtained, indicating that block 1 in frame 1 is displaced by motion vector 1 and reaches the position of block 2 in frame 2. According to block 2 and block 3, motion vector 2 (the arrow between the block 2 and the block 3 in FIG. 2) can be obtained, indicating that the block 2 in the frame 2 is displaced by the motion vector 2 and reaches the position of the block 3 in the frame 3. According to the displacement pattern, the motion vector 3′ can be inferred analogously, as indicated by the arrow between the block 3 and block 3′ in FIG. 2, indicating that the block 3 in the frame 3 is displaced by the motion vector 3′ and reaches the position of predicted frame block 3′. As shown in FIG. 2, the motion vector 1 and the motion vector 2 are the same in direction and displacement, and it is assumed that the motion vector 3 (the motion vector corresponding to frames 4 and 3, not shown in the figure) should also be the same as the motion vector 2. Moreover, since the motion vector 3 corresponds to the displacement of the matching block between the frame 4 and the frame 3, the frame 3′ is the predicted frame between the frame 3 and the frame 4, so the motion vector 3 has the same direction, but a half displacement size as the motion vector 1 and the motion vector 2. The above frame 1, frame 2, frame 3, and frame 4 all are rendered source frames.

In this embodiment, in order to increase the frame rate, the predicted frame is inserted between the two source frames. Therefore, when the motion vector 3′ is preset, the displacement size becomes half. In other embodiments, if the frame rate is not required to be increased, then, in the process of acquiring the motion vector 3′ in the above example, the direction and the displacement size of motion vector 3′ remains the same as the direction and the displacement size of motion vector 1 or the motion vector 2, respectively.

In addition to the above manner (step 221), in other embodiments, the foregoing step 22 may also be implemented in one of the following ways:

Method 1: at least two frame motion vectors are calculated according to the Kalman filter algorithm to obtain a frame motion vector prediction value.

Kalman filtering is an algorithm that uses the linear system state equation to optimally estimate the state of the system through input and output observation data of the system. Since the observation data includes the effects of noise and interference in the system, the optimal estimate can also be considered as a filtering process.

Method 2: an artificial neural network algorithm model obtained by training is used to predict the frame motion vector prediction value.

For example, according to a machine learning algorithm such as an artificial neural network, relevant parameters such as frame image, attitude information, and motion vector are input for training to obtain an algorithm model. Then, real-time parameters are input into the model, thereby outputting a predicted frame motion vector and a predicted frame.

In one embodiment, the foregoing step 23 can be implemented in the following manner:

Processing a source frame closest to the frame motion vector prediction value according to the frame motion vector prediction value to obtain a predicted frame.

As shown in FIG. 2, the frame obtained by shifting the pixels in the unit block in the frame 3 in accordance with the motion vector 3′ is the predicted frame. That is, the pixels in the unit block of the frame 3 are correspondingly shifted according to the displacement vector 3′of the corresponding predicted frame. In case of unable to fill, an interpolation process can be performed according to a certain rule, or pixels the unit block in the position corresponding to third frame image are directly used to fill.

In one embodiment, the image frame prediction method, before the performing inter-frame motion vector calculation on every two adjacent source frames to obtain a plurality of frame motion vectors, further includes extracting two adjacent source frames from a storage module.

In one embodiment, the two adjacent source frames comprises a first source frame and a second source frame, a predicted frame of the first source frame is a copy of the first source frame, and a predicted frame of the second source frame is a copy of the second source frame.

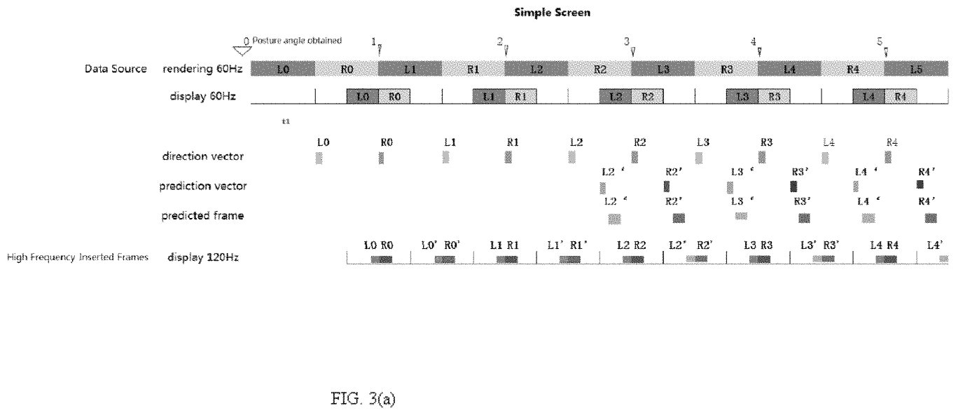

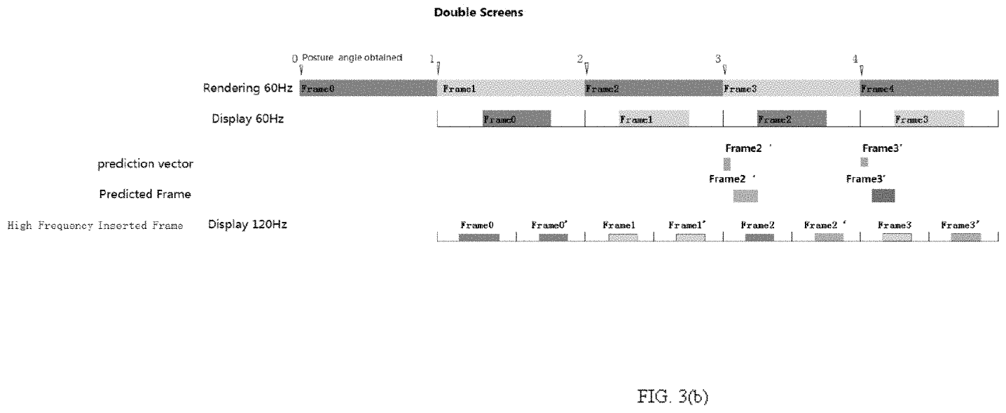

FIG. 3(a) shows an application of the image frame prediction method to an single screen AR/VR head display apparatus. FIG.3(b) shows an application of the image frame prediction method to a double screens AR/VR head display apparatus. As shown in FIG. 3(a), the display 120 Hz shows a first frame (left 0 right 0), a first predicted frame (left 0′ right 0′), a second frame (left 1 right 1), and a second predicted frame (left 1′ right 1′) before the predicted frame 2′ (left 2′ right 2′). As shown in FIG. 3 (b), the display 120 Hz shows a first frame (frame 0), a first predicted frame (flame 0′), a second frame (frame 1), and a second predicted frame (frame 1′) before the predicted frame 2′. Thus, the display is delay is significantly reduced.

The present disclosure provides a low-latency spatial prediction driving scheme and apparatus, and replaces the GPU rendering image interpolation scheme with a post-image processing interpolation scheme. The predicted frame is generated by the corresponding algorithm, not generated by the rendering, which can reduce the scene rendering workload, reduce the amount of intermediate data transmission, and make the product more portable. The delay is low, which avoids the situation of dropping frames due to insufficient rendering ability, and improves the value, performance and quality of the corresponding products.

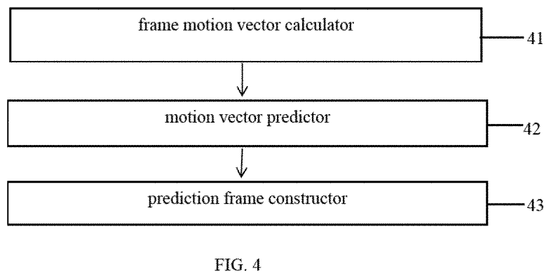

One embodiment of the present disclosure further provides an image frame prediction apparatus, as shown in FIG. 4, comprising: a frame motion vector calculator 41, a motion vector predictor 42, and a prediction frame constructor 43, wherein:

The frame motion vector calculator 41 is configured to perform inter-frame motion vector calculation on two adjacent source frames to obtain a frame motion vector of the adjacent two source frames, where the source frames are rendered frames.

The motion vector predictor 42 is configured to perform inter-frame motion vector prediction based on at least two frame motion vectors to obtain a frame motion vector prediction value.

The prediction frame constructor 43 is configured to process a source frame closest to the frame motion vector prediction value according to the frame motion vector prediction value to obtain a predicted frame.

In one embodiment, the apparatus further includes an interpolation frame processor, configured to insert the predicted frame after the source frame that is closest to the frame motion vector prediction value. The source frame closest to the frame motion vector prediction value is the last source frame used in calculating the frame motion vector prediction value.

In one embodiment, the frame motion vector calculator 41 is configured to divide the first source frame into a plurality of unit blocks, and find a matching block in the second source frame corresponding to each unit block in the first source frame, calculate a motion vector between each unit block in the first source frame and its corresponding matching block, and obtain a frame motion vector between the first source frame and the second source frame.

In one embodiment, the motion vector predictor 42 obtains a frame motion vector prediction value in one of the following manners:

Inferring the frame motion vector prediction value by analogy based on the frame motion vectors and the displacement pattern;

Calculating the frame motion vector prediction value based on at least two frame motion vectors according to a Kalman filter algorithm; or

Predicting the frame motion vector prediction value by using the artificial neural network algorithm model derived from training.

In one embodiment, the prediction frame constructor 43 is configured to perform, according to the frame motion vector prediction value, a displacement of a pixel in a unit block in the last source frame used in calculating the frame motion vector prediction value, and to get the predicted frame.

For specific examples in this embodiment, reference may be made to the examples described in the foregoing method embodiments and the optional embodiments, and details are not described herein again.

One embodiment of the present disclosure further provides an AR or VR head display apparatus including the above image frame prediction apparatus.

The AR or VR head display apparatus in one embodiment of the present disclosure can reduce the data processing load on the system side, and weaken dependence on the system performance. Compared with the existing equipment, the system external apparatus requirements, the built-in processor requirements, and the heat dissipation requirements are reduced. At the same time, the system can be more portable because the amount of data transmitted between, the system processing module and other modules is reduced, that is, the number of transmission wires is reduced, the number of data processing ICs at the transceiver end is reduced, or the specification is reduced. In addition, since it is not necessary to render the frames to be displayed in real time, only part of the frame is rendered to ensure the accuracy of the partial frame, and other frames to be displayed are predicted (that is, the predicted frame motion vector is combined with the rendered source frame) and not by rendering. The delay is reduced, and the situation of dropping frames due to insufficient rendering ability is avoided. Accordingly, the value, performance, and quality of the corresponding products are improved.

### Application Examples

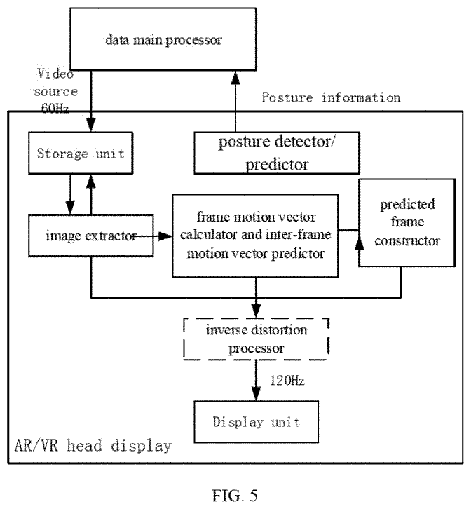

A system according to one embodiment of the present disclosure includes a data main processor and an AR/VR head display. The main functional block diagram of the system is shown in FIG. 5.

The data main processor such as application processor (AP), PC, cloud, etc., wherein the main functions are to provide content such as scenes, videos, pictures, games, etc has image processing capabilities such as rendering.

The data main processor and the head display may be connected by wireless, or may be connected by a transmission line.

The data main processor transmits the scene and the like at a general frame rate required for the head display, or at a lower frame rate. In one embodiment, the data main processor provides 60 Hz content, and the head display requires a frame rate of 120 Hz. In one embodiment, the data main processor provides 30 Hz content, and the head display requires a frame rate of 90 Hz, etc.. Then, estimation of a plurality of frame motion vector prediction values and construction of corresponding predicted frames may be performed.

Some module functions of the AR/VR head display are described below:

A posture detector/predictor is a module that can provide a current head-on attitude and provide a prediction of an attitude of next time. The posture detector/predictor may be an inertial measurement unit (IMU), optical sensor positioning, camera ranging, and the like.

A storage unit is used to store data content provided by the data main processor.

An image extracting unit is configured to read the current source frame data from the storage module, and submit the data to the frame motion vector calculation and inter-frame motion vector prediction module to infer the frame motion vector prediction value; and to extract the pre-source frame data, and transmit the data to the inverse distortion processor to perform inverse distortion processing or to the display unit for display.

A frame motion vector calculation and inter-frame motion vector predictor is used for calculating a frame motion vector of a current source frame and an adjacent source frame; and obtaining a frame motion vector prediction value based on adjacent frame motion vectors, that is, the possible frame motion vector of the predicted frame, or motion vector prediction. This unit corresponds to the frame motion vector calculator 41 and the motion vector predictor 42 in the above embodiments.

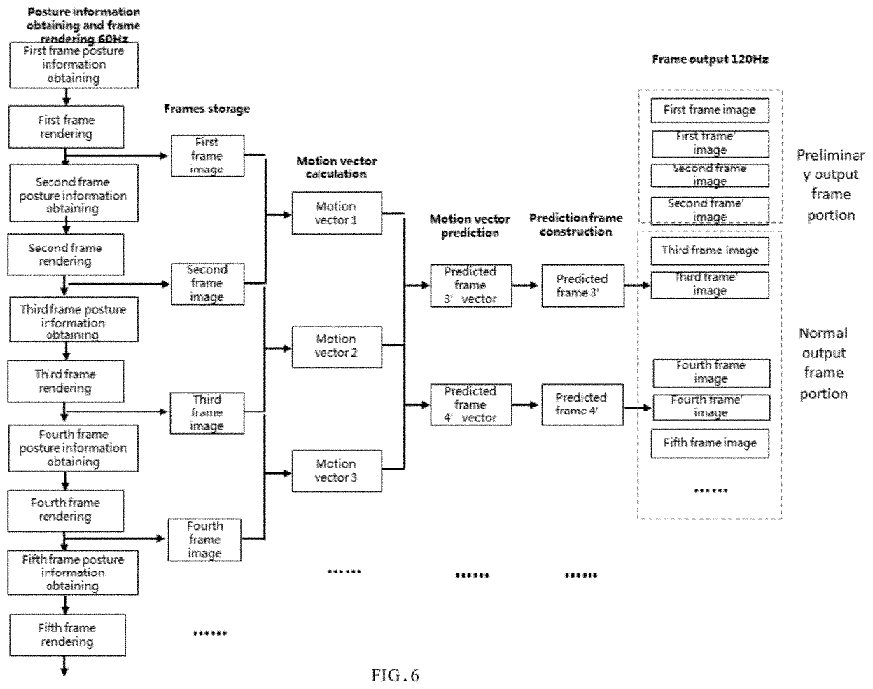

A predicted frame constructor is, for the normal output frame portion in FIG. 5, used for calculating a possible motion vector of the predicted frame obtained according to the frame motion vector calculation and inter-frame motion vector predictor, and combining the source frame closest to the predicted frame to construct a predicted frame. For the preliminary output frame portion of FIG. 6, the predicted frame constructor is used for constructing the preliminary output frame. The preliminary output frame can be simply obtained by, for example, frame repetition, frame averaging, etc.. This corresponds to the predicted frame constructor 43 in the above embodiment.

An inverse distortion processor is provided. If the display portion uses a lens to generate distortion, the inverse distortion processor is configured to perform inverse distortion processing before the image is output, and the processed image is then output.

A display unit is used for receiving current frame source data and predicted frame data, performing data sorting, and outputting to the display module.

The calculation modules involved in this example can exist in FPGAs, CPUs, custom ICs, MCUs, etc., and are not limited herein.

As shown in FIG. 6, the frame output portion can be divided into a preliminary output frame portion and a normal output frame portion. The normal output frame portion is composed of a data source rendered frame and a predicted frame. The corresponding predicted frame is constructed by obtaining frame motion vectors from the rendered frames, and then inferring the frame motion vector prediction value from the adjacent frame motion vectors. The intermediate frame of the preliminary output frame such as frame image 1′ and frame image 2′ in FIG. 6 can be simply derived by, for example, copying.

The transmission content and processing scheme of the scene (the content source of the video or picture content related to the helmet posture) is as shown in FIG. 6, and the source of 60 Hz and the display of 120 Hz are taken as an example for description.

The head display obtains frame attitude information such as a posture angle through the attitude detector/predictor, and transmits it to the data main processor, and the data main processor performs frame rendering and transmits the rendered frame content to the head display.

The head display receives the frame content rendered by the main processor for storage.

The image extracting unit provides content of the first source frame and the second source frame to the frame motion vector calculation and inter-frame motion vector predictor to performs frame motion vector calculation; and provides the source frame relating to the preliminary output frame (that is, the source frame involved in obtaining the preliminary output frame) to the display unit or the inverse distortion processor at an appropriate time to perform frame output.

The frame motion vector calculation and inter-frame motion vector predictor obtains the frame motion vector prediction value based on the frame motion vectors of adjacent two source frames and obtain the predicted frame according to the frame motion vector prediction value combined with the corresponding source frame.

The source frame and the predicted frame are output according to the requirements of the display module data source. If the display portion uses the lens to generate distortion, the image to be output is inversely distorted by the inverse distortion processor before the image is output, and then output to the display unit. If the display portion does not use a lens or does not require inverse distortion processing, the image is directly output to the display unit. Those skilled in the art are familiar with how to use the existing inverse distortion algorithm for inverse distortion processing, which will not be described herein.

In this example, the motion vector prediction value calculation is predicted based on two adjacent frame motion vectors. If it is feasible to use adjacent three or more frames, using multiple frames can improve the accuracy. When performing prediction using Kalman fillet or the like, the preliminary output frame may include more frames.

This embodiment of the present disclosure is applicable to all scenarios for motion estimation by motion vectors, and is applicable to AR/VR spatial prediction, and also to other scenarios that need to be inserted into a frame, or a scenario in which frame prediction is required.

One embodiment of the present disclosure further provides a computer storage medium, where the computer storage medium stores a computer program. After the computer program is executed, the image frame prediction method provided by one or more embodiments such as the method shown in FIG. 2 can be implemented.

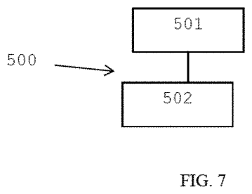

As shown in FIG. 7, one of the embodiments of the present disclosure provides a computer product 500, which includes one or more processors 502. The one or more processors are configured to execute computer instructions to perform one or more steps of the forgoing rendering method according to one embodiment of the present disclosure.

Optionally, the computer product 500 includes a storage 501 that connects to processor 502. The storage is configured to store commands of the computer instruction.

The storage 501 can be implemented by any type of volatile or non-volatile storage device or a combination therefor, such as static random-access memory (SRAM), electrically erasable programmable read-only memory (EEPROM), erasable programmable read-only memory (EPROM), read-only memory (ROM), magnetic memory, flash memory, disk, or optical disk.

In one embodiment, the processor 502 is a central processor (CPU) or a field-programmable logic array (FPGA), a microcontroller (MCU), a digital signal processor (DSP), an application-specific integrated circuit (ASIC), or a graphics processor (GPU) having processing power and/or program execution capability. One or more processors may be configured to form a processor group to simultaneously execute the above-described rendering method. Alternatively, some of the processors perform partial steps of the above-described rendering method, and some of the processors perform other partial steps of the above-described rendering methods.

The computer readable program instructions may be loaded onto a computer, other programmable data processing apparatus, or other device to cause a series of operational steps to be performed on the computer, other programmable apparatus or other device to produce a computer implemented process.

The computer product 500 can be connected to various input devices (such as a user-interface, a keyboard, etc.), various output devices (such as speakers, network cards, etc), and display apparatuses to achieve the interaction of computer products with other products or users exchanges, and the description thereof will not be repeated here.

Wherein, the connection may be through a network connection, such as a wireless network, a wired network, and/or any combination of a wireless network and a wired network. The network may include a local area network, the internet, a telecommunications network (Internet of Things), and/or any combination of the above-networks, etc. The wired is network can communicate by means of twisted pair, coaxial cable or optical fiber transmission. A wireless communication network such as 3G/4G/5G mobile communication network, Bluetooth, Zigbee or Wi-Fi can be used.

Those of ordinary skill in the art will appreciate that all or some of the steps, systems, and functional blocks/units of the methods disclosed above may be implemented as software, firmware, hardware, and suitable combinations thereof. In a hardware implementation, the division between functional modules/units mentioned in the above description does not necessarily correspond to the division of physical units. For example, one physical component can have multiple functions, or one function or step can be performed cooperatively by several physical components. Some or all of the components may be implemented as software executed by a processor such as a digital signal processor or microprocessor, or as hardware, or as an integrated circuit such as an application specific integrated circuit. Such software may be distributed on a computer readable medium, which may include computer storage media (or non-transitory media), and communication media (or transitory media). As is well known to those of ordinary skill in the art, the term computer storage medium includes both volatile and nonvolatile, removable and non-removable media implemented in any method or technology for storing information (such as computer readable instructions, data structures, program modules, or other data). Computer storage media includes, but is not limited to, RAM, ROM, EEPROM, flash memory or other memory technology, CD-ROM, digital versatile disc (DVD) or other optical disc storage, magnetic cassette, magnetic tape, magnetic disk storage or other magnetic storage apparatus, or any other medium that can be used to store the desired information and that can be accessed by the computer. Moreover, it is well known to those skilled in the art that communication media typically includes computer readable instructions, data structures, program modules, or other data in a modulated data signal, such as a carrier wave or other transport mechanism, and can include any information delivery media.

The principles and the embodiments of the present disclosure are set forth in the specification. The description of the embodiments of the present disclosure is only used to help understand the apparatus and method of the present disclosure and the core idea thereof. Meanwhile, for a person of ordinary skill in the art, the disclosure relates to the scope of the disclosure, and the technical scheme is not limited to the specific combination of the technical features, but also covers other technical schemes which are formed by combining the technical features or the equivalent features of the technical features without departing. from the inventive concept. For example, a technical scheme may be obtained by replacing the features described above as disclosed in this disclosure (but not limited to) with similar features.

1. An method of image frame prediction in a display apparatus, comprising:
performing inter-frame motion vector calculation on every two adjacent source frames to obtain a plurality of frame motion vectors, wherein the source frames are rendered frames;
performing inter-frame motion vector prediction based on at least two adjacent frame motion vectors of the plurality of frame motion vectors to obtain a frame motion vector prediction value; and
processing a source frame closest to the frame motion vector prediction value based on the frame motion vector prediction value to obtain a predicted frame,
wherein the source frame closest to the frame motion vector prediction value is the last source frame used in obtaining the frame motion vector prediction value.

2. The method according to claim 1, further comprising:
inserting the predicted frame after the source frame closest to the frame motion vector prediction value.

3. The method according to claim 1, wherein the every two adjacent source frames comprises a first source frame and a second source frame, the second source frame is a subsequent frame of the first source frame in time series, and performing inter-frame motion vector calculation on every two adjacent source frames to obtain the plurality of frame motion vectors comprises:
dividing the first source frame into a plurality of unit blocks;
finding a matching block in the second source frame corresponding to each of the plurality of unit blocks in the first source frame:
calculating a motion vector between each of the plurality of unit blocks in the first source frame and its corresponding matching block in the second source frame, thereby obtaining a frame motion vector between the first source frame and the second source frame.

4. The method according to claim 1, wherein performing inter-frame motion vector prediction based on at least two adjacent frame motion vectors of the plurality of frame motion vectors to obtain a frame motion vector prediction value comprises:
inferring the frame motion vector prediction value based on the at least two adjacent frame motion vectors and a displacement pattern;
calculating the frame motion vector prediction value based on the at least two adjacent frame motion vectors according to a Kalman filter algorithm; or using an artificial neural network algorithm model derived from training to predict the frame motion vector prediction value.

5. The method according to claim 3, wherein processing the source frame closest to the frame motion vector prediction value based on the frame motion vector prediction value to obtain the predicted frame comprises:
shifting pixels in the unit blocks in the source frame closest to the frame motion vector prediction value according to the frame motion vector prediction value to obtain the predicted frame.

6. The method according to claim 1, before the performing inter-frame motion vector calculation on every two adjacent source frames to obtain a plurality of frame motion vectors, further comprising:
extracting two adjacent source frames from a storage module.

7. The method according to claim 2, wherein the display apparatus comprises a lens capable of generating distortion, further comprising:
performing inverse distortion processing on he predicted frame and the source frame.

8. The method according to claim 2, after inserting the predicted frame after the source frame closest to the frame motion vector prediction value, further comprising:
outputting the predicted frame and the source frame closest to the frame motion to a display module.

9. The method according to claim 1, wherein the two adjacent source frames comprises a first source frame and a second source frame, a predicted frame of the first source frame is a copy of the first source frame, and a predicted frame of the second source frame is a copy of the second source frame.

10. An image frame prediction apparatus, comprising:
a frame motion vector calculator,
a motion vector predictor, and
a prediction frame constructor,
wherein the frame motion vector calculator is configured to perform inter-frame motion vector calculation on every two adjacent source frames to obtain frame motion vectors of the every two adjacent source frames, where the source frames are rendered frames;
the motion vector predictor is configured to perform inter-frame motion vector prediction based on at least two adjacent frame motion vectors of the plurality of frame motion vectors to obtain a frame motion vector prediction value: and
the prediction frame constructor is configured to process a source frame closest to the frame motion vector prediction value according to the frame motion vector prediction value to obtain a predicted frame,
wherein the source frame closest to the frame motion vector prediction value is the last source frame used in obtaining the frame motion vector prediction value.

11. The image frame prediction apparatus according to claim 10, further comprising an inserting frame processor,
wherein the inserting frame processor is configured to insert the predicted frame behind the source frame closest to the frame motion vector prediction value.

19. The image frame prediction apparatus according to claim 11, further comprising an inverse distortion processor before the inserting frame processor,
wherein the inverse distortion processor is configured to perform inverse distortion processing on the predicted frame.

13. The image frame prediction apparatus according to claim 10, wherein the every two adjacent source frames comprises a first source frame and a second source frame, the second source frame is a subsequent frame of the first source frame in time series, and
the frame motion vector calculator is configured to divide the first source frame into a plurality of unit blocks; find a matching block in the second source frame corresponding to each of the plurality of unit blocks in the first source frame; and calculate a motion vector between each of the plurality of unit blocks in the first source frame and its corresponding matching block in the second source frame to obtain a frame motion vector between the first source frame and the second source frame.

14. The image frame prediction apparatus according to claim 10, wherein the motion vector predictor obtains the frame motion vector prediction value in one of the following manners:
inferring the frame motion vector prediction value based on the at least two adjacent frame motion vectors and a displacement pattern;
calculating the frame motion vector prediction value based on the at least two adjacent frame motion vectors according to a Kalman filter algorithm; or
using an artificial neural network algorithm model derived from training to predict the frame motion vector prediction value.

15. The image frame prediction apparatus according to claim 13, wherein, the prediction flame constructor is configured to shift pixels in the unit blocks in the source frame closest to the frame motion vector prediction value according to the frame motion vector prediction value to obtain the predicted frame.

16. The image frame prediction apparatus according to claim 10, further comprising an image extractor before the frame motion vector calculator, wherein the image extracting unit. is configured to extract two adjacent source frames from a storage module.

17. A head display apparatus, comprising the image frame prediction apparatus according to claim 10.

18. A computer product, comprising one or more processors, the one or more processors is configured to implement the image frame prediction method according to claim 1. cm 19. A non-transitory computer-readable medium storing instructions that cause a computer to execute the method according to claim 1.
